(19) United States
(12) Patent Application Publication
(10) Pub. No.: US 2026/0244150 A1
(43) Pub. Date: Aug. 20, 2026

(54) SHEET CONVEYANCE APPARATUS, IMAGE READING APPARATUS, AND IMAGE FORMING APPARATUS

(71) Applicant: CANON KABUSHIKI KAISHA, Tokyo (JP)

(72) Inventor: SHOGO YAMASAKI, Chiba (JP)

(21) Appl. No.: 19/533,990

(22) Filed: Feb. 9, 2026

(30) Foreign Application Priority Data
Feb. 20, 2025 (JP) 2025-025966

(51) Int. Cl. G03G 15/00; B65H 5/02

(52) U.S. Cl. CPC G03G 15/754; B65H 5/025; G03G 15/5054

(57) ABSTRACT

A sheet conveyance apparatus includes a motor unit, a drive pulley, a first driven pulley, a second driven pulley, an endless first belt, an endless second belt, a pulley support member, a tensioner, a fixing member, and a pivot-forming portion. The tensioner is interposed between the pulley support member and the motor support member, and applies a reaction force corresponding to an external force acting on the motor support member to the motor support member. The fixing member fixes the pulley support member and the motor support member each other, and is screwed about a second center line. The pivot-forming portion forms a pivot point corresponding to a third center line about which the motor support member pivots with respect to the pulley support member, and receives a torque generated between the pulley support member and the motor support member when the fixing member is screwed.

### BACKGROUND

### Field of the Technology

The present disclosure relates to a sheet conveyance apparatus, an image reading apparatus, and an image forming apparatus that convey sheets.

### Description of Related Art

Hitherto, regarding image reading apparatuses or image forming apparatuses, such as copying machines and digital multifunction machines, that are equipped with image reading apparatuses, a sheet conveyance apparatus is adopted widely in which a plurality of driven pulleys that are disposed coaxially with and rotate integrally with a driving roller for conveying sheets are connected via a plurality of belts to one drive pulley. According to such a configuration in which a plurality of pulleys are mutually connected via belts, a configuration is proposed in which sliding is less likely to occur during drive transmission via belts to realize high accuracy of sheet conveyance speed. For example, Japanese Patent Application Laid-Open Publication No. 2004-85890 proposes a configuration in which a plurality of driven pulleys that are disposed coaxially and belts wound around the respective pulleys are arranged movably in a direction of a tensioner with respect to a drive motor, and fixed at positions balanced by the tensioner via screw members used for fixing. According to this configuration, driven pulleys are disposed at appropriate positions through use of the tensioner and fixed by screwing, such that sliding is less likely to occur during drive transmission via belts.

However, according to the configuration disclosed in Japanese Patent Application Laid-Open Publication No. 2004-85890, after determining the relative position of the plurality of driven pulleys that are disposed coaxially and the drive motor, when engaging the pulleys by screwing, the torque generated by screwing may cause a support member of the driven pulleys to move. If the support member of the driven pulleys is moved, the tension of the belts wound around the pulleys may be reduced.

### SUMMARY

The present disclosure provides a sheet conveyance apparatus, an image reading apparatus, and an image forming apparatus that can suppress the reduction of tension of belts caused by the torque generated during screwing.

According to a first aspect of the present disclosure, a sheet conveyance apparatus configured to convey a sheet includes a motor unit including a drive motor having a drive shaft, and a motor support member supporting the drive motor, a drive pulley fixed to the drive shaft of the drive motor and configured to rotate about a first center line, a first driven pulley, a second driven pulley, an endless first belt wound around the drive pulley and the first driven pulley, the first belt being configured to transmit a rotation of the drive pulley to the first driven pulley, an endless second belt wound around the drive pulley and the second driven pulley, the second belt being configured to transmit a rotation of the drive pulley to the second driven pulley, a pulley support member supporting the first driven pulley and the second driven pulley, a tensioner interposed between the pulley support member and the motor support member, the tensioner being configured to apply a reaction force corresponding to an external force acting on the motor support member to the motor support member, a fixing member configured to fix the pulley support member and the motor support member each other, the fixing member being screwed about a second center line that differs from the first center line, and a pivot-forming portion configured to form a pivot point corresponding to a third center line, that differs from both the first center line and the second center line, about which the motor support member pivots with respect to the pulley support member, the pivot-forming portion being configured to receive a torque generated between the pulley support member and the motor support member in a state where the fixing member is screwed.

According to a second aspect of the present disclosure, a sheet conveyance apparatus configured to convey a sheet includes a motor unit including a drive motor having a drive shaft, and a motor support member supporting the drive motor, a drive pulley fixed to the drive shaft of the drive motor and configured to rotate about a first center line, a first driven pulley, a second driven pulley, an endless first belt wound around the drive pulley and the first driven pulley, the first belt being configured to transmit a rotation of the drive pulley to the first driven pulley, an endless second belt wound around the drive pulley and the second driven pulley, the second belt being configured to transmit a rotation of the drive pulley to the second driven pulley, a pulley support member supporting the first driven pulley and the second driven pulley, a tensioner interposed between the pulley support member and the motor support member, the tensioner being configured to apply a reaction force corresponding to an external force acting on the motor support member to the motor support member, a pivot-forming portion configured to form a pivot point corresponding to a third center line, that differs from the first center line, about which the pulley support member and the motor support member are rotatable each other in a state where the external force acting on the motor support member and the reaction force applied to the motor support member from the tensioner are balanced, and a fixing member configured to fix the pulley support member and the motor support member each other, the fixing member being screwed about a second center line that differs from both the first center line and the third center line after the pivot point is formed between the pulley support member and the motor support member by the pivot-forming portion, and the fixing member being configured to have the pivot-forming portion receive a torque generated between the pulley support member and the motor support member in a state where the fixing member is screwed.

According to a third aspect of the present disclosure, an image reading apparatus includes the sheet conveyance apparatus configured to support a sheet, and an image reading unit configured to read an image formed on a sheet conveyed by the sheet conveyance apparatus.

According to a fourth aspect of the present disclosure, an image forming apparatus includes the image reading apparatus configured to read an image formed on a sheet, and an image forming unit configured to form an image onto a sheet.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view in which an image forming apparatus according to a first embodiment is viewed from a front side.

FIG. 2 is a cross-sectional view in which the image reading apparatus according to the first embodiment is viewed from the front side.

FIG. 3 is a perspective view illustrating a conveyance unit and a motor unit of the image reading apparatus according to the first embodiment.

FIG. 4 is a perspective view illustrating a portion of the conveyance unit and the motor unit of the image reading apparatus according to the first embodiment.

FIG. 5 is an exploded perspective view illustrating a portion of the conveyance unit and the motor unit of the image reading apparatus according to the first embodiment.

FIG. 6A is a perspective view illustrating a portion of the conveyance unit and the motor unit of the image reading apparatus according to the first embodiment, illustrating a state prior to attaching a tension spring.

FIG. 6B is a perspective view illustrating a portion of the conveyance unit and the motor unit of the image reading apparatus according to the first embodiment, illustrating a state after attaching the tension spring.

FIG. 7 is a perspective view illustrating a state of screwing a portion of the conveyance unit and the motor unit of the image reading apparatus according to the first embodiment.

FIG. 8 is a schematic drawing illustrating an external force acting on the motor unit of the image reading apparatus according to the first embodiment.

FIG. 9A is a schematic drawing illustrating a relationship between forces of a motor unit and a drive support plate of an image reading apparatus according to a comparative example, illustrating a state prior to attaching a screw.

FIG. 9B is a schematic drawing illustrating the relationship between forces of the motor unit and the drive support plate of the image reading apparatus according to the comparative example, illustrating a state after engaging a screw.

FIG. 9C is a cross-sectional view illustrating a screw of the image reading apparatus according to the comparative example.

FIG. 10A is a schematic drawing illustrating a relationship between forces of the motor unit and the drive support plate of the image reading apparatus according to the first embodiment, illustrating a state prior to attaching a screw.

FIG. 10B is a schematic drawing illustrating a relationship between forces of the motor unit and the drive support plate of the image reading apparatus according to the first embodiment, illustrating a state prior to tightening the screw.

FIG. 11A is a schematic drawing illustrating a relationship between forces of a motor unit and a drive support plate of an image reading apparatus according to a second embodiment, illustrating a state prior to tightening a screw.

FIG. 11B is a schematic drawing illustrating a relationship between forces of the motor unit and the drive support plate of the image reading apparatus according to the second embodiment, illustrating a state after tightening the screw.

FIG. 12A is a schematic drawing illustrating a relationship between forces of a motor unit and a drive support plate of an image reading apparatus according to a comparative example, illustrating a state prior to tightening a screw.

FIG. 12B is a schematic drawing illustrating a relationship between forces of the motor unit and the drive support plate of the image reading apparatus according to the comparative example, illustrating a state after tightening the screw.

### DESCRIPTION OF THE EMBODIMENTS

### First Embodiment

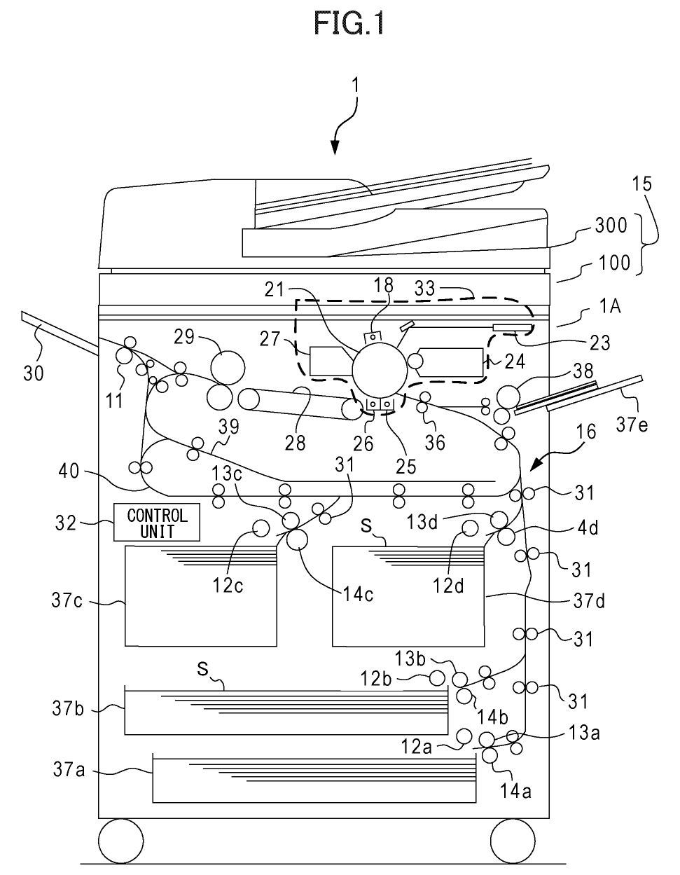

A first embodiment of the present disclosure will be described in detail below with reference to FIGS. 1 to 10B. The present embodiment illustrates a case in which a monochromatic printer adopting an electrophotographic system is applied as one example of an image forming apparatus 1. The present disclosure is not limited to the image forming apparatus 1 of a monochromatic printer adopting an electrophotographic system, and the present disclosure may be applied to a full-color printer, or even to an image forming apparatus adopting a tandem-type system or an inkjet recording system.

### Image Forming Apparatus

A schematic configuration of the image forming apparatus 1 equipped with an image reading apparatus 15 will be described with reference to FIG. 1. FIG. 1 is a cross-sectional view of the image forming apparatus 1 according to the present embodiment. In the following description, a position from which the user performs various input/setting operations to an operation portion not shown with respect to the image forming apparatus 1 is referred to as a “front direction” of the image forming apparatus 1, and a back side thereof is referred to as a “rear side”. That is, FIG. 1 illustrates an internal configuration of the image forming apparatus 1 viewed from the front direction.

An apparatus body 1A includes an image forming unit 33 for forming an image on a sheet S serving as a recording medium, and a sheet feeding unit 16 configured to feed the sheet S to the image forming unit 33. The sheet feeding unit 16 includes sheet storage portions 37a, 37b, 37c, and 37d capable of accommodating sheets having different sizes. The sheets accommodated in each of the sheet storage portions 37a, 37b, 37c, and 37d are fed by pickup rollers 12a, 12b, 12c, and 12d. The sheets are separated one by one by feed rollers 13a, 13b, 13c, and 13d and retard rollers 14a, 14b, 14c, and 14d, and transferred to corresponding conveyance roller pairs 31. The sheets S are sequentially transferred to a plurality of conveyance roller pairs 31 that are arranged along a sheet conveyance path to be conveyed to a registration roller pair 36.

The sheet S placed on a manual feed tray 37e by the user is fed to an interior of the apparatus body 1A by a feed roller 38 and conveyed to the registration roller pair 36. The registration roller pair 36 corrects skewing of the sheet S by stopping a leading edge of the sheet S, and resumes conveyance of the sheet S in accordance with the advancement of image forming operation, which is a forming process of a toner image by the image forming unit 33.

The image forming unit 33 forms an image on the sheet S based on information of an image read by the image reading apparatus 15. The image forming unit 33 is an electrophotographic unit including a photosensitive drum 21 serving as a photosensitive member. The photosensitive drum 21 is rotatable along a conveyance direction of the sheet S, and in the circumference of the photosensitive drum 21 are disposed a charging unit 18, an exposing unit 23, a developing unit 24, a transfer charger 25, a separation charger 26, and a cleaner 27. The charging unit 18 charges a surface of the photosensitive drum 21 uniformly. The exposing unit 23 exposes the photosensitive drum 21 based on an image information entered from the image reading apparatus 15, and forms an electrostatic latent image on the photosensitive drum 21.

The developing unit 24 accommodates a two-component developer including a toner and a carrier, and by supplying charged toner to the photosensitive drum 21, the electrostatic latent image is developed into a toner image. The toner image borne on the photosensitive drum 21 is transferred to the sheet S conveyed from the registration roller pair 36 by a bias electric field formed by the transfer charger 25. The sheet S having the toner image transferred thereto is separated from the photosensitive drum 21 by a bias electric field formed by the separation charger 26, and conveyed by a pre-fixing conveyance unit 28 toward a fixing unit 29. Attachments such as transfer residual toner remaining on the photosensitive drum 21 without being transferred to the sheet S are removed by the cleaner 27, and the photosensitive drum 21 prepares for the subsequent image forming operation.

The sheet S conveyed to the fixing unit 29 is heated and pressed while being nipped by a roller pair, by which the toner is melted and solidified, such that the image is fixed to the sheet S. In a state where image output is completed, the sheet S to which a fixed image is formed is discharged via a sheet discharge roller pair 11 to a sheet discharge tray 30 protruded outward from the apparatus body 1A. When forming an image on a rear surface of the sheet S in duplex printing, the sheet S having passed through the fixing unit 29 has its front and rear sides reversed by a reverse portion 39, and is conveyed to the registration roller pair 36 by a duplex conveyance portion 40. The sheet S having an image formed thereto again by the image forming unit 33 is discharged onto the sheet discharge tray 30. Image Reading Apparatus

The image reading apparatus 15 disposed above the apparatus body 1A of the image forming apparatus 1 includes a scanner unit 100 and an auto document feeder (ADF) 300, and optically scans a document to read image information therefrom. The image information that is converted into electric signals by the image reading apparatus 15 is transferred via a controller not shown to a control unit 32 disposed on the apparatus body 1A. Thereby, the image forming apparatus 1 forms an image on a recording medium based on an image information read by the image reading apparatus 15.

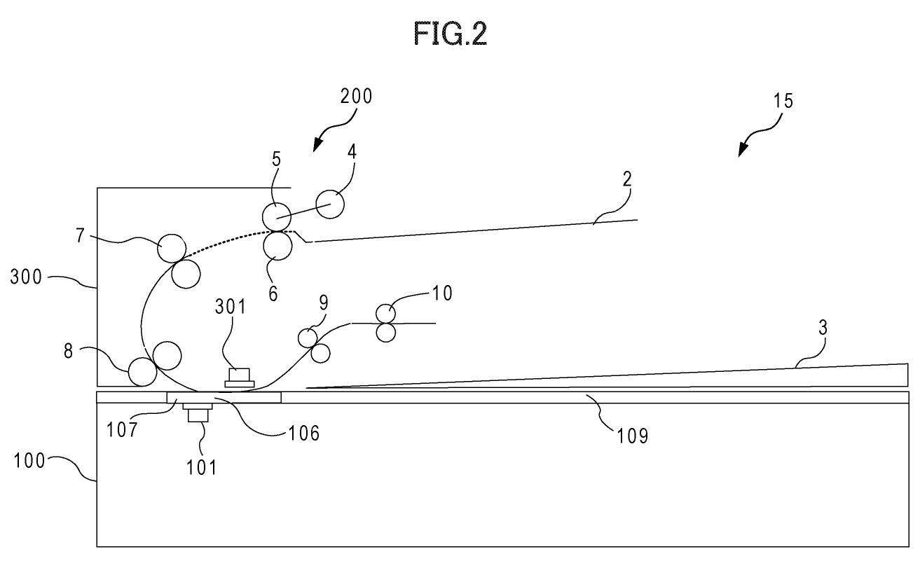

FIG. 2 is a cross-sectional view illustrating an example of the image reading apparatus 15 according to the present embodiment. The scanner unit 100 includes a surface reading unit 101, a document feeding-reading glass 106, and a platen glass 109. The scanner unit 100 performs reading of an image by driving a document motor not shown to move the surface reading unit 101 via a belt and read the surface of the document placed on the platen glass 109 one line at a time.

The surface reading unit 101 is an example of an image reading unit, and it reads the image formed on the surface of the sheet S conveyed by the ADF 300. A contact image sensor, hereinafter referred to as CIS, is used as the surface reading unit 101. The document feeding-reading glass 106 is disposed to read the image of the document conveyed via the ADF 300 onto the document feeding-reading glass 106 by the surface reading unit 101.

The ADF 300 is an example of a sheet conveyance apparatus for conveying the sheet S, and includes a document tray 2, a conveyance unit 200, a rear surface reading unit 301, and a sheet discharge tray 3. The conveyance unit 200 includes a pickup roller 4, a feed roller 5, a separation roller 6, a first roller 7 serving as a drawing roller, a second roller 8, a third roller 9, and a sheet discharge roller 10. The rear surface reading unit 301 is an example of an image reading unit, and reads an image formed on a rear surface of the sheet S conveyed by the ADF 300. A CIS is adopted, for example, as the surface reading unit 101. A rotational axis direction D1 of the respective rollers of the conveyance unit 200 is parallel with a scanning direction of the surface reading unit 101, and in the present embodiment, it is a front-rear direction.

By having the pickup roller 4 fall onto an uppermost surface of a document bundle supported on the document tray 2 and rotate thereon, the document on the uppermost surface of the document bundle is conveyed. One sheet on the uppermost surface of the document conveyed by the pickup roller 4 is separated and conveyed by an action of the separation roller 6. This separation is realized by a well-known separation technique. The sheet S being separated has its leading edge abut against the first roller 7 that has stopped pivoting. The sheet S is continued to be conveyed by the feed roller 5 while the first roller 7 is stopped, such that a loop is formed to the sheet S and skewing of the sheet S is removed, i.e., skew correction is performed. The sheet S subjected to skew correction is conveyed by the first roller 7 to the second roller 8. The images on both sides of the sheet S being conveyed is read by the surface reading unit 101 and the rear surface reading unit 301, before the sheet S is conveyed by the third roller 9, and is sequentially discharged and supported on a supporting portion of the sheet discharge tray 3 by the sheet discharge roller 10.

### Conveyance Unit and Motor Unit

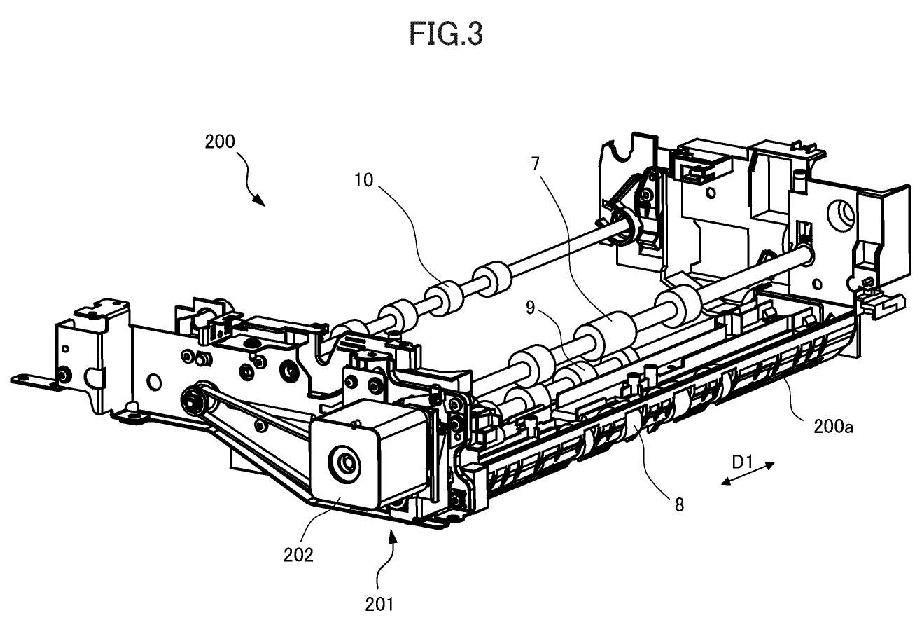

FIG. 3 is a perspective view of the conveyance unit 200 adopted in the ADF 300 according to the present embodiment. As illustrated in FIG. 3, the conveyance unit 200 includes a conveyance frame 200a. Both ends of the first roller 7, the second roller 8, the third roller 9, and the sheet discharge roller 10 are rotatably supported by the conveyance frame 200a. Further, a motor unit 201 is attached to the conveyance unit 200.

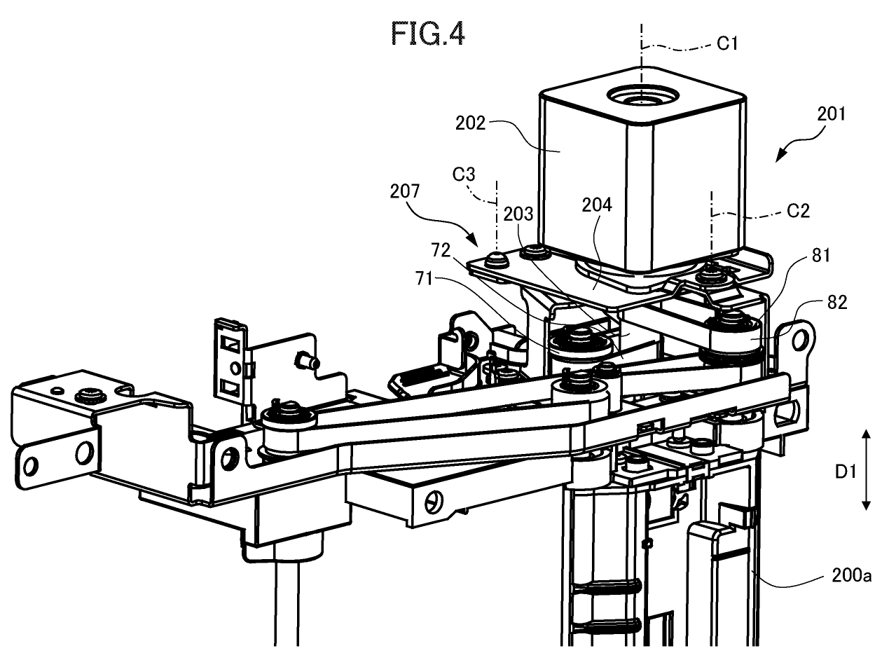

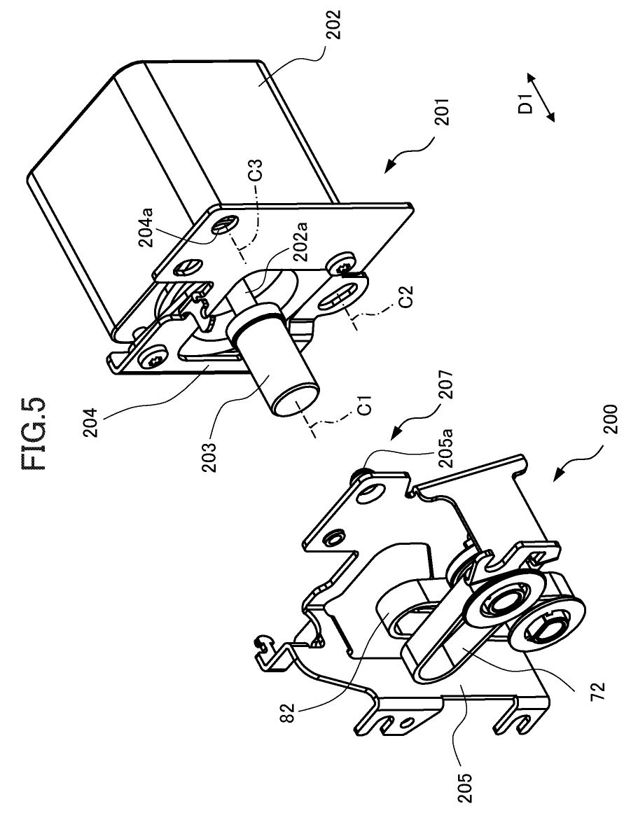

FIG. 4 is a perspective view illustrating a periphery of a drive motor 202 of the conveyance unit 200. As illustrated in FIG. 4, the motor unit 201 is disposed on a first end portion of the conveyance frame 200a in the rotational axis direction D1. The motor unit 201 includes the drive motor 202 having a drive shaft 202a (refer to FIG. 5), and a motor support plate 204 having an approximately planar shape and serving as an example of a motor support member on which the drive motor 202 is supported. A drive pulley 203 is fixed to rotate integrally with the drive shaft 202a of the drive motor 202. The drive pulley 203 is fixed to the drive shaft 202a and disposed rotatably about a first center line C1.

The drive pulley 203 is connected by a first belt 72 with respect to a first driven pulley 71 disposed coaxially with the first roller 7 so as to rotate integrally therewith, and transmits a driving force to the first driven pulley 71. The first roller 7 is arranged coaxially with the first driven pulley 71 and rotates in an interlocked manner with the first driven pulley 71 to convey the sheet S. The first belt 72 is an example of an endless first belt, wound around the drive pulley 203 and the first driven pulley 71, and transmits the rotation of the drive pulley 203 to the first driven pulley 71.

The drive pulley 203 is connected via a second belt 82 to a second driven pulley 81 disposed coaxially with and rotates integrally with the second roller 8, and transmits a driving force to the second driven pulley 81. The second roller 8 is disposed coaxially with the second driven pulley 81 and conveys the sheet S by rotating in an interlocked manner with the second driven pulley 81. The second belt 82 is an example of an endless second belt, which is wound around the drive pulley 203 and the second driven pulley 81 to transmit the rotation of the drive pulley 203 to the second driven pulley 81.

The conveyance frame 200a supports the first roller 7 and the second roller 8 rotatably, such that the first driven pulley 71 and the second driven pulley 81 are supported rotatably by the conveyance frame 200a, which is an example of a pulley support member. According to the present embodiment, the first driven pulley 71 and the second driven pulley 81 are arranged such that a straight line L11 connecting the first center line C1 and a rotation center line of the first driven pulley 71 intersects orthogonally with a straight line L12 connecting the first center line C1 and a rotation center line of the second driven pulley 81.

### Attachment Procedure of Motor Unit

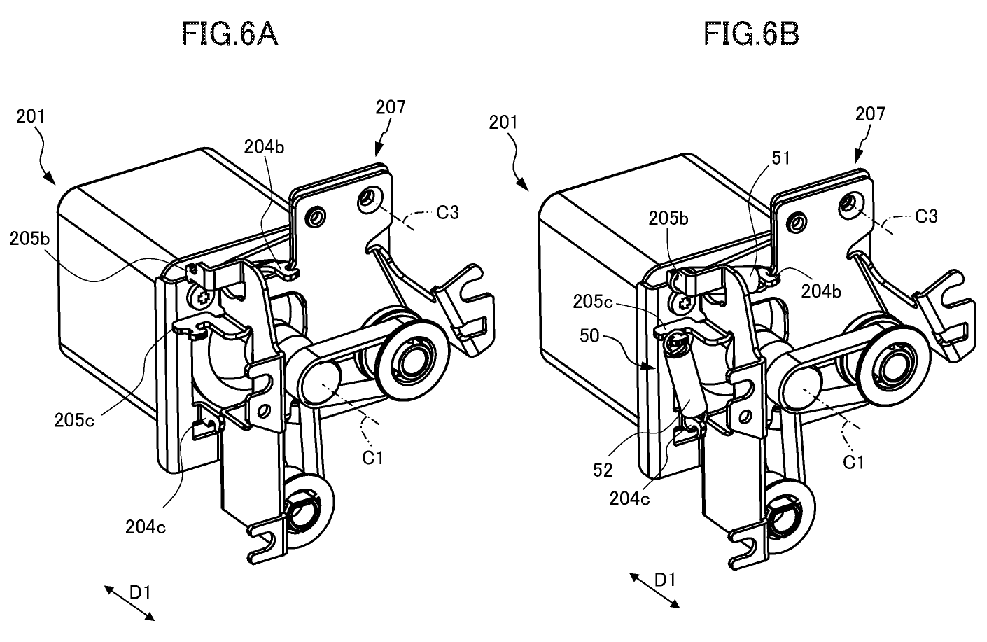

Next, an assembly procedure of the conveyance unit 200 will be described with reference to FIGS. 5 to 7. As illustrated in FIG. 5, in the motor unit 201, the drive motor 202 is fixed by screwing to the motor support plate 204. When attaching the motor unit 201 to the conveyance unit 200, the motor support plate 204 is attached to the drive support plate 205 which is attached so as to constitute a portion of the conveyance frame 200a. In this state, the drive pulley 203 is inserted such that the first belt 72 and the second belt 82 are wound thereon. Thereby, as illustrated in FIG. 6A, the motor support plate 204 is assembled to the drive support plate 205.

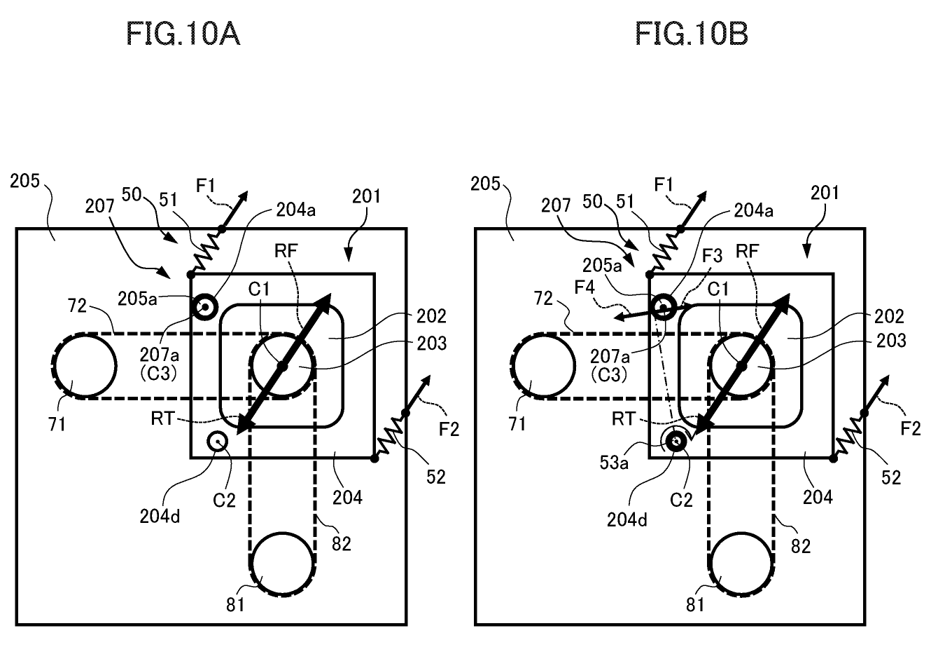

In this state, a pivot-forming portion 207 that forms a pivot point 207a (refer to FIG. 10A) corresponding to a third center line C3, that differs from both the first center line C1 and the second center line C2, about which the motor support plate 204 pivots with respect to the conveyance frame 200a, i.e., the drive support plate 205, is disposed between the motor support plate 204 and the drive support plate 205. The third center line C3 is arranged at a position that differs from the first center line C1. The pivot-forming portion 207 includes a support hole 204a formed on the motor support plate 204, and a pivot shaft 205a serving as one example of a support shaft disposed on the drive support plate 205. The pivot shaft 205a is inserted to the support hole 204a and disposed pivotably about the third center line C3. According to the present embodiment, the support hole 204a is formed on the motor support plate 204 and the pivot shaft 205a is disposed on the drive support plate 205, but the present technique is not limited thereto. For example, the motor support plate 204 may be provided with the pivot shaft, and the drive support plate 205 may have a support hole formed thereto. That is, the support shaft having the third center line C3 set as the center is formed on one of the drive support plate 205 and the motor support plate 204, and a support hole to which the support shaft is engaged is formed on the other one of the drive support plate 205 and the motor support plate 204.

In the state illustrated in FIG. 6A, a tensioner 50 is attached. The tensioner 50 is interposed between the drive support plate 205 and the motor support plate 204, and applies a reaction force corresponding to an external force acting on the motor support plate 204 to the motor support plate 204. The tensioner 50 includes a first urging spring 51 and a second urging spring 52, both of which are composed of a tension coil spring. The motor support plate 204 includes hooks 204b and 204c, and the drive support plate 205 includes hooks 205b and 205c. The first urging spring 51 is extended between the hook 204b of the motor support plate 204 and the hook 205b of the drive support plate 205. The second urging spring 52 is extended between the hook 204c of the motor support plate 204 and the hook 205c of the drive support plate 205. This state is illustrated in FIG. 6B.

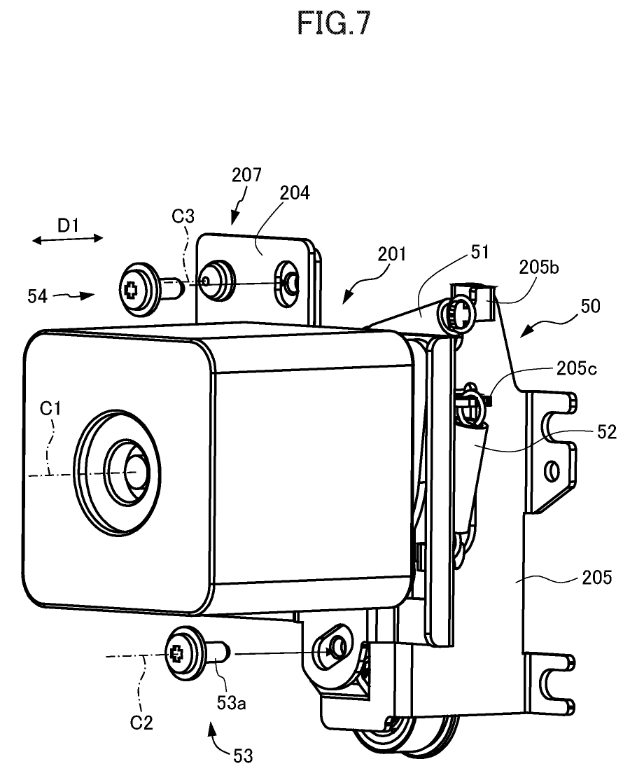

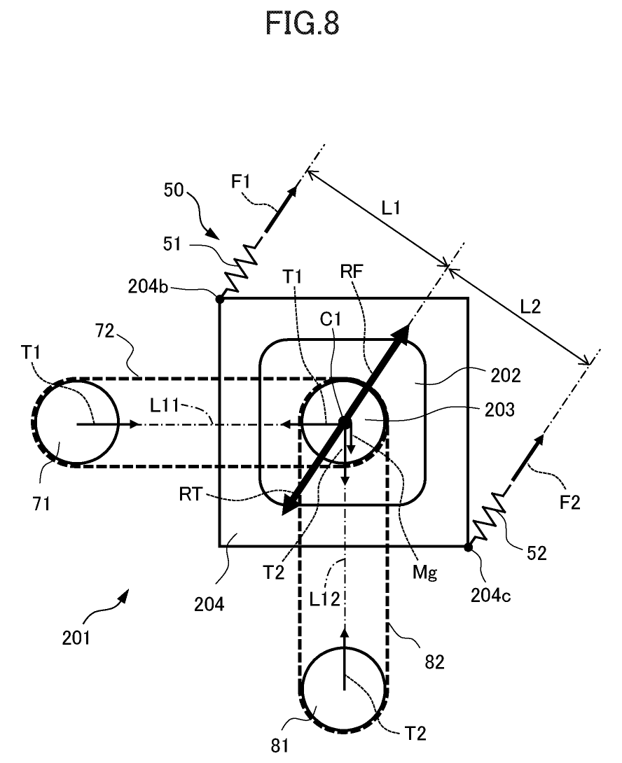

That is, the first urging spring 51 urges the motor support plate 204 via the hook 204b serving as an example of a first urging position. The second urging spring 52 urges the motor support plate 204 via the hook 204c serving as an example of a second urging position that differs from the hook 204b. The force that the tensioner 50 applies to the motor support plate 204 is a resultant force, i.e., reaction force RF, of a tension F1 serving as an example of a first urging force by the first urging spring 51 and a tension F2 serving as an example of a second urging force by the second urging spring 52 (refer to FIG. 8). Tension is applied to the first belt 72 and the second belt 82 by the reaction force RF. Further, as illustrated in FIG. 7, the motor support plate 204 is engaged and fixed to the drive support plate 205 by screws 53 and 54 serving as an example of a fixing member.

As described, according to the present embodiment, a first step of assembling the pivot-forming portion 207, and thereafter, a second step of engaging the screw 53 are executed as a procedure for attaching the motor unit 201 to the conveyance unit 200. In the first step, the pivot-forming portion 207 forms the pivot point 207a about which the drive support plate 205 and the motor support plate 204 are rotatable to each other about the third center line C3, in a state where the external force acting on the motor support plate 204 and the reaction force applied to the motor support plate 204 from the tensioner 50 are balanced. After forming the pivot point 207a by the pivot-forming portion 207 in the first step, the drive support plate 205 and the motor support plate 204 are fixed to each other by screwing the screw 53 about a second center line C2 set as the center in the second step. The screw 53 is a right-hand screw. As described later, when screwing the screw 53, the torque generated between the drive support plate 205 and the motor support plate 204 by screwing is received by the pivot-forming portion 207.

### Tension of Respective Units

Next, a state of the tension in the motor unit 201 and the conveyance unit 200 will be described with reference to FIGS. 8 to 11B. FIG. 8 is a schematic drawing illustrating an external force acting on the drive pulley 203. The tension acting on the first belt 72 is referred to as T1, the tension acting on the second belt 82 is referred to as T2, and the weight of the motor unit 201 is referred to as Mg. In this state, RT, which is a resultant force of T1, T2, and Mg, acts on the center of the drive pulley 203. In the present embodiment, the total weight of the motor unit 201 is supported on the drive pulley 203. However, the present technique is not limited thereto, and in a state where a portion of weight of the motor unit 201 is supported on portions other than the drive pulley 203, the weight having subtracted such portion of weight is referred to as Mg. That is, the external force acting on the motor support plate 204 is the resultant force RT of the tension T1 of the first belt 72, the tension T2 of the second belt 82, and at least a part of the weight of the motor unit 201.

In order to determine the position of the drive motor 202 and to have the drive motor 202 stand still in a balanced state with respect to the resultant force RT without performing screwing, the conditions of the tensioner 50 are set as follows. That is, the tensioner 50 applies a force in an opposite direction as the resultant force RT as the reaction force RF to the motor support plate 204. The reaction force RF refers to a force that acts in the opposite direction as the resultant force RT and that has a force approximately equal to the resultant force RT.
(1) The reaction force RF, which is a resultant force of the tension F1 of the first urging spring 51 and the tension F2 of the second urging spring 52, is balanced with the resultant force RT (Condition (1)).
(2) The moment acting about the center of the drive pulley 203 is balanced. That is, F1 × L1 = F2 × L2 is satisfied (Condition (2)).

### Comparative Example

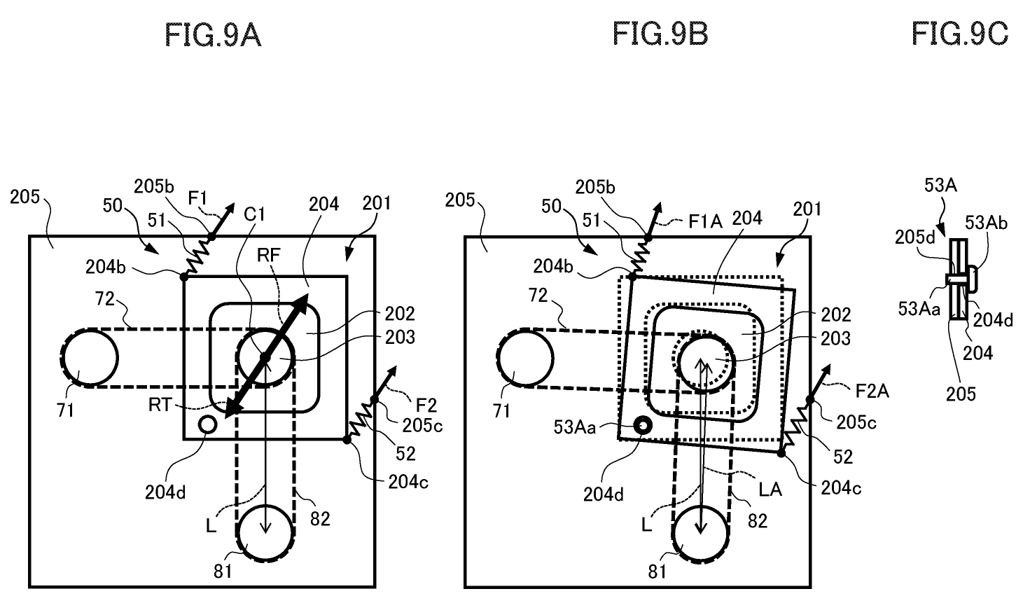

Now, as a comparative example, a relationship between forces of the motor support plate 204 and the drive support plate 205 in a state where the pivot-forming portion 207 is not provided will be described with reference to FIGS. 9A to 9C. FIG. 9A is a schematic drawing illustrating the motor unit 201 that is standing still with the tension balanced by the tensioner 50 in a state where the pivot-forming portion 207 is not provided. As illustrated in FIG. 9A, with respect to the motor unit 201 in a standstill state by the tension balanced with conditions (1) and (2) being satisfied, a screw 53A is used for engagement to retain the conditions.

As illustrated in FIG. 9C, the screw 53A is engaged to a thread hole 205d formed on the drive support plate 205 and a through hole 204d formed on the motor support plate 204. In this state, a screw portion 53Aa of the screw 53A passes through the through hole 204d and is screwed onto the thread hole 205d, and a screw head 53Ab comes into contact with a surface of the motor support plate 204, by which the motor support plate 204 is fixed to the drive support plate 205.

A case in which the screw 53A is used for engagement in the state of FIG. 9A is illustrated in FIG. 9B. As illustrated in FIG. 9B, the torque generated by the screw 53A during engagement causes the motor unit 201 to pivot about the screw 53A. In this state, the respective first ends of the first urging spring 51 and the second urging spring 52 are hooked on the drive support plate 205 in a stand still state, such that the tension F1 of the first urging spring 51 is reduced to a tension F1A. Further, a distance L between a center of the drive pulley 203 and a center of the second roller 8 becomes a distance LA shorter than L, such that the tension of the second belt 82 is reduced and sheet conveyance may not be normally executed. Therefore, according to the present embodiment, the pivot-forming portion 207 is provided, such that when screw-engaging the motor unit 201, the balanced tension is varied as little as possible.

### Present Embodiment

FIGS. 10A and 10B are each a schematic drawing illustrating a state in which the motor unit 201 is fixed in a stand still state where tension is balanced by the tensioner 50, in a case where the pivot-forming portion 207 is disposed. As illustrated in FIG. 10A, the screw 53 is used to perform engagement while maintaining conditions of the motor unit 201 that satisfies conditions (1) and (2) that is and standing still in a balanced state with the pivot shaft 205a inserted to the support hole 204a. That is, the screw 53 is an example of a fixing member that fixes the drive support plate 205 and the motor support plate 204 each other, the screw 53 being screwed about the second center line C2 that differs from the first center line C1 and the third center line C3 serving as a center. Further according to the present embodiment, the first center line C1, the second center line C2, and the third center line C3 are arranged in parallel.

As illustrated in FIG. 10B, the motor unit 201 attempts to pivot about the screw 53, but the pivot shaft 205a is inserted in the support hole 204a, such that pivoting is prevented. In this state, the support hole 204a applies a force F3 to the pivot shaft 205a by an engagement torque of the screw 53. Simultaneously, the support hole 204a receives a force F4 from the pivot shaft 205a, but since F3 is equal to F4 based on a law of action and reaction, the motor unit 201 maintains a standing still state. That is, the pivot-forming portion 207 receives a torque generated between the drive support plate 205 and the motor support plate 204 by the screwing of the screw 53. In the present embodiment, there is almost no gap formed between a screw portion 53a of the screw 53 and the through hole 204d, such that the motor support plate 204 will not easily move with respect to the screw 53 even by tightening the screw 53.

As illustrated above, according to the ADF 300 of the present embodiment, the pivot-forming portion 207 is disposed between the motor unit 201 and the conveyance unit 200. Thereby, when screwing the motor unit 201 and the conveyance unit 200 by the screw 53, it may be possible to suppress pivoting caused by the torque generated during screwing, and it may be possible to suppress the respective tensions of the first belt 72 and the second belt 82 from being reduced.

According to the present embodiment, the positional arrangement of the pivot-forming portion 207 is as illustrated in FIG. 10A, but the present technique is not limited thereto. That is, according to the present embodiment, there is almost no gap formed between the screw portion 53a of the screw 53 and the through hole 204d, and even when the screw 53 is tightened, the motor support plate 204 will not easily move with respect to the screw 53. Therefore, in a state where the pivot-forming portion 207 and the screw 53 are at different positions, the pivoting of the motor support plate 204 by the tightening of the screw 53 can be suppressed. In the present embodiment, the distance between the pivot-forming portion 207 and the screw 53 is set longer than a distance between a rotation center of the drive pulley 203 and the screw 53. That is, a distance between the third center line C3 and the second center line C2 is set longer than a distance between the first center line C1 and the second center line C2. Thereby, the distance between the pivot-forming portion 207 and the screw 53 is set sufficiently long, such that the effect of suppressing pivoting of the motor support plate 204 by the tightening of the screw 53 may be enhanced. Further, the effect may be further enhanced as the distance between the pivot-forming portion 207 and the screw 53 elongates.

### Second Embodiment

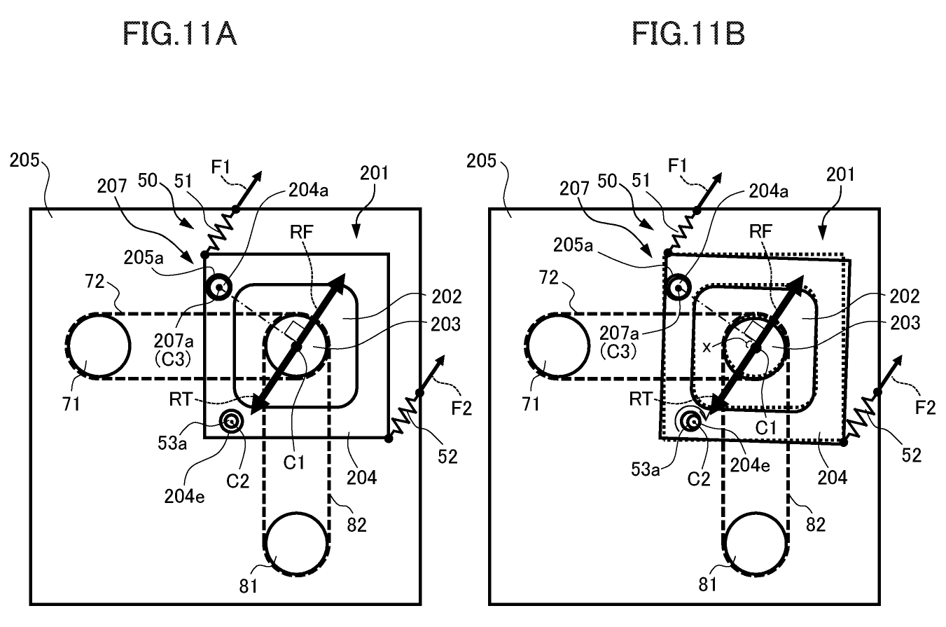

Next, a second embodiment will be described with reference to FIGS. 11A and 11B. The present embodiment differs from the first embodiment in that there is a gap formed between the screw portion 53a of the screw 53 and a through hole 204e, and that a backlash occurs when screwing the screw 53. The other configurations are similar to the first embodiment, such that components are denoted with the same reference numbers, and detailed descriptions are omitted.

FIGS. 11A and 11B are each a schematic drawing in which the motor unit 201 whose tension is balanced by the tensioner 50 and is in a stand still state is fixed. As illustrated in FIG. 11A, the screw 53 is used to engage the motor unit 201 that satisfies conditions (1) and (2) and that is balanced and in a stand still state with the pivot shaft 205a inserted to the support hole 204a so as to maintain the above-mentioned conditions. In this state, according to the present embodiment, a greater gap compared to the case of the first embodiment exists between the screw portion 53a of the screw 53 and the through hole 204e. In general, the gap is caused by component tolerances. In a state where a gap exists, when the screw 53 is screw-engaged, the motor unit 201 pivots about the pivot shaft 205a corresponding to the amount of gap.

According to the present embodiment, the pivot-forming portion 207 is arranged such that a force vector of the resultant force RT is orthogonal to a straight line connecting the first center line C1 and the third center line C3 when viewed in an axial direction of the first center line C1. That is, lines of action of the resultant force RT and the reaction force RF and a straight line connecting the center of the pivot shaft 205a and the center of the drive pulley 203 are approximately orthogonal to each other.

According further to the present embodiment, the third center line C3 is positioned upstream of the first center line C1 in a screw tightening direction of screwing of the screw 53 when viewed in the axial direction of the first center line C1. Since the screw 53 is a right-hand screw, by tightening the screw 53, the motor support plate 204 pivots in a right rotation direction about the pivot point 207a. In this state, since the lines of action of the resultant force RT and the reaction force RF and a straight line connecting the center of the pivot shaft 205a and the center of the drive pulley 203 are approximately orthogonal, the drive pulley 203 moves along the lines of action of the resultant force RT and the reaction force RF.

As illustrated in FIG. 11B, by the motor unit 201 pivoting corresponding to the amount of gap, the drive pulley 203 moves for a movement amount x on the lines of action of the resultant force RT and the reaction force RF. Since the lines of action of the resultant force RT and the reaction force RF and a straight line connecting the center of the pivot shaft 205a and the center of the drive pulley 203 are approximately orthogonal, the movement amount x is minute. The influence caused by the movement of the movement amount x is considered to be the variation of tensions F1 and F2 of the tensioner 50, but since the movement amount x is minute, the tension of the first belt 72 and the second belt 82 increases, such that the influence on condition (1) can be ignored. Further, since the movement of the motor unit 201 is a movement on the lines of action of the resultant force RT and the reaction force RF, the influence on condition (2) can be ignored.

As described above, according to the ADF 300 of the present embodiment, the lines of action of the resultant force RT and the reaction force RF and the straight line connecting the center of the pivot shaft 205a and the center of the drive pulley 203 are approximately orthogonal. Therefore, by disposing the pivot point 207a at such a position, reduction of belt tension by screw engaging torque when fixing the motor unit 201 can be prevented.

### Comparative Example

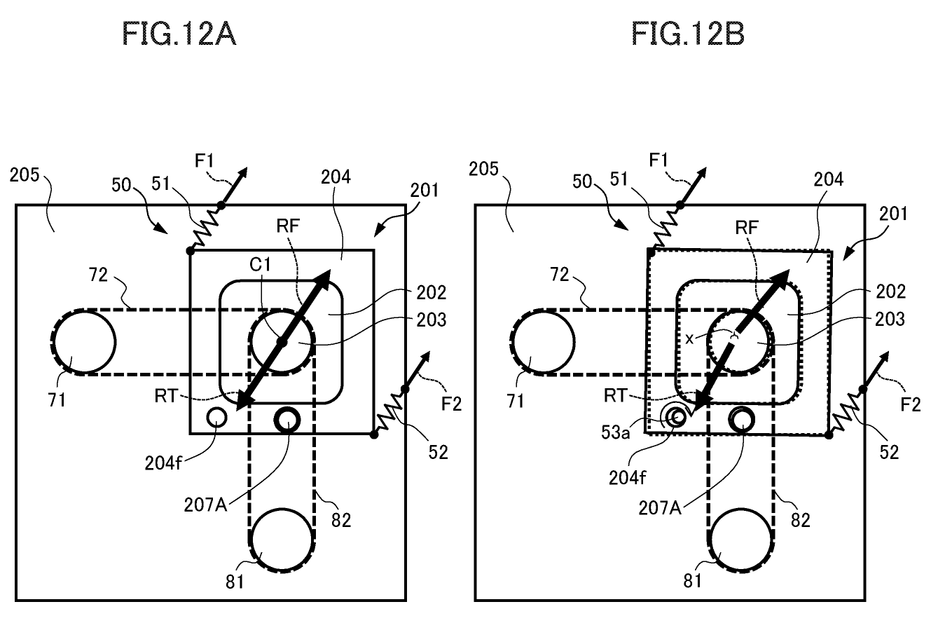

A comparative example of a case where a gap is formed between the screw portion 53a of the screw 53 and a through hole 204f is illustrated with reference to FIGS. 12A and 12B. As illustrated in FIGS. 12A and 12B, according to the comparative example, a pivot-forming portion 207A is arranged in an inner circumference portion of the second belt 82 when viewed in an axial direction of the first center line C1. That is, a straight line connecting a center of the pivot shaft 205a and a center of the drive pulley 203 are not orthogonal, not even roughly orthogonal, to the lines of action of the resultant force RT and the reaction force RF.

In this state, by tightening the screw 53, the drive pulley 203 is moved for a minute movement amount x, but the movement direction is not on the lines of action of the resultant force RT and the reaction force RF. By the effect of movement of the drive pulley 203 for the movement amount x, the lines of action of the resultant force RT and the reaction force RF are no longer on a same straight line, such that both conditions (1) and (2) are not satisfied, the effect on the tension can no longer be ignored, and the tension of the belt may be reduced.

Even if the pivot-forming portion is arranged at a position where the straight line connecting the center of the pivot shaft 205a and the center of the drive pulley 203 is not approximately orthogonal to the lines of action of the resultant force RT and the reaction force RF, the reduction of tension of the belt may be suppressed similarly as the first embodiment as long as no backlash occurs.

According to the present disclosure, the reduction of tension of the belt caused by the torque occurring by screwing may be suppressed.

### Other Embodiments

According to the respective embodiments described above, a case in which the first center line C1, the second center line C2, and the third center line C3 are parallel with each other is illustrated, but the present technique is not limited thereto. The respective lines may be displaced from the parallel relationship.

According further to the respective embodiments, the number of belts wound around the drive pulley 203 is two, but the present technique is not limited thereto, and the number of belts may be three or more.

According further to the present embodiment, a case in which the sheet conveyance apparatus is applied to the image reading apparatus 15 was described, but the present technique is not limited thereto. The sheet conveyance apparatus of the present disclosure can be applied to any sheet conveyance apparatus that conveys sheets in the image reading apparatus 15 or the image forming apparatus 1.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-025966, filed February 20, 2025, which is hereby incorporated by reference herein in its entirety.

What is claimed is:

1. A sheet conveyance apparatus configured to convey a sheet, the sheet conveyance apparatus comprising:
a motor unit including a drive motor having a drive shaft, and a motor support member supporting the drive motor;
a drive pulley fixed to the drive shaft of the drive motor and configured to rotate about a first center line;
a first driven pulley;
a second driven pulley;
an endless first belt wound around the drive pulley and the first driven pulley, the first belt being configured to transmit a rotation of the drive pulley to the first driven pulley;
an endless second belt wound around the drive pulley and the second driven pulley, the second belt being configured to transmit a rotation of the drive pulley to the second driven pulley;
a pulley support member supporting the first driven pulley and the second driven pulley;
a tensioner interposed between the pulley support member and the motor support member, the tensioner being configured to apply a reaction force corresponding to an external force acting on the motor support member to the motor support member;
a fixing member configured to fix the pulley support member and the motor support member each other, the fixing member being screwed about a second center line that differs from the first center line; and
a pivot-forming portion configured to form a pivot point corresponding to a third center line, that differs from both the first center line and the second center line, about which the motor support member pivots with respect to the pulley support member, the pivot-forming portion being configured to receive a torque generated between the pulley support member and the motor support member in a state where the fixing member is screwed.

2. The sheet conveyance apparatus according to claim 1, wherein the first center line, the second center line, and the third center line are arranged in parallel.

3. The sheet conveyance apparatus according to claim 1,
wherein the external force acting on the motor support member is a resultant force of a tension of the first belt, a tension of the second belt, and at least a part of a weight of the motor unit, and
wherein the tensioner is configured to apply a force in an opposite direction as the resultant force as the reaction force to the motor support member.

4. The sheet conveyance apparatus according to claim 1, wherein a force vector of a resultant force of a tension of the first belt, a tension of the second belt, and a weight of the drive motor is orthogonal to a straight line connecting the first center line and the third center line when viewed in an axial direction of the first center line.

5. The sheet conveyance apparatus according to claim 4, wherein the third center line is positioned upstream of the first center line in a screw tightening direction of the fixing member when viewed in the axial direction of the first center line.

6. The sheet conveyance apparatus according to claim 1, wherein the first driven pulley and the second driven pulley are arranged such that a straight line connecting the first center line and a rotation center line of the first driven pulley intersects a straight line connecting the first center line and a rotation center line of the second driven pulley when viewed in an axial direction of the first center line.

7. The sheet conveyance apparatus according to claim 1,
wherein the tensioner includes a first urging spring configured to urge the motor support member at a first urging position of the motor support member, and a second urging spring configured to urge the motor support member at a second urging position, which differs from the first urging position, of the motor support member, and
wherein the reaction force that the tensioner applies to the motor support member is a resultant force of a first urging force by the first urging spring and a second urging force by the second urging spring.

8. The sheet conveyance apparatus according to claim 1, wherein the pivot-forming portion includes a support shaft formed on one of the pulley support member and the motor support member, the support shaft having the third center line as a center, and a support hole formed on the other of the pulley support member and the motor support member, the support hole in which the support shaft is engaged.

9. The sheet conveyance apparatus according to claim 1, further comprising:
a first roller disposed coaxially with the first driven pulley, and configured to rotate in an interlocked manner with the first driven pulley to convey a sheet; and
a second roller disposed coaxially with the second driven pulley, and configured to rotate in an interlocked manner with the second driven pulley to convey the sheet.

10. The sheet conveyance apparatus according to claim 1, wherein a distance between the third center line and the second center line is longer than a distance between the first center line and the second center line.

11. A sheet conveyance apparatus configured to convey a sheet, the sheet conveyance apparatus comprising:
a motor unit including a drive motor having a drive shaft, and a motor support member supporting the drive motor;
a drive pulley fixed to the drive shaft of the drive motor and configured to rotate about a first center line;
a first driven pulley;
a second driven pulley;
an endless first belt wound around the drive pulley and the first driven pulley, the first belt being configured to transmit a rotation of the drive pulley to the first driven pulley;
an endless second belt wound around the drive pulley and the second driven pulley, the second belt being configured to transmit a rotation of the drive pulley to the second driven pulley;
a pulley support member supporting the first driven pulley and the second driven pulley;
a tensioner interposed between the pulley support member and the motor support member, the tensioner being configured to apply a reaction force corresponding to an external force acting on the motor support member to the motor support member;
a pivot-forming portion configured to form a pivot point corresponding to a third center line, that differs from the first center line, about which the pulley support member and the motor support member are rotatable each other in a state where the external force acting on the motor support member and the reaction force applied to the motor support member from the tensioner are balanced; and
a fixing member configured to fix the pulley support member and the motor support member each other, the fixing member being screwed about a second center line that differs from both the first center line and the third center line after the pivot point is formed between the pulley support member and the motor support member by the pivot-forming portion, and the fixing member being configured to have the pivot-forming portion receive a torque generated between the pulley support member and the motor support member in a state where the fixing member is screwed.

12. An image reading apparatus comprising:
the sheet conveyance apparatus according to claim 1 configured to support a sheet; and
an image reading unit configured to read an image formed on a sheet conveyed by the sheet conveyance apparatus.

13. An image forming apparatus comprising:
the image reading apparatus according to claim 12 configured to read an image formed on a sheet; and
an image forming unit configured to form an image onto a sheet.
